(19) United States
(12) Patent Application Publication
(10) Pub. No.: US 2025/0199860 A1
(43) Pub. Date: Jun. 19, 2025

(54) FLEXIBLE ALLOCATION OF PROCESSORS FOR SAFETY-CRITICAL AND NON-CRITICAL APPLICATIONS

(71) Applicants: Advanced Micro Devices, Inc., Santa Clara, CA (US); ATI Technologies ULC, Markham (CA)

(72) Inventors: Kaushal A. Sanghai, Boxborough, MA (US); Carl K. Wakeland, Santa Clara, CA (US); UmaSankara Rao Balla, Hyderabad (IN); Andy Sung, Markham (CA); Balatripura S. Chavali, Austin, TX (US)

(73) Assignees: Advanced Micro Devices, Inc., Santa Clara, CA (US); ATI Technologies ULC, Markham, ON (CA)

(21) Appl. No.: 18/543,627

(22) Filed: Dec. 18, 2023

(51) Int. Cl. G06F 9/50

(52) U.S. Cl. CPC G06F 9/5027

(57) ABSTRACT

Devices and methods for allocating components of a safety critical system are provided. The processing device comprises resources including memory, a host processor and a plurality of processors connected to the resources via a shared pathway of a network and configured to execute an application based on instructions from the host processor. Each of the plurality of processors is assigned to one of a plurality of criticality domain levels and isolated pathways are created, via the shared pathway, between the plurality of processors and the plurality of resources based on which of the processors are assigned to one or more of the plurality of criticality domain levels to access one or more of the plurality of resources. The application is executed using the network. The isolated pathways are, for example, created by disabling one or more switches. Alternatively, the isolated pathways are created via programmable logic.

### BACKGROUND

Safety critical systems, which typically include multiple processors, are used in a variety of industries, such as for example the automotive industry, the medical industry, the railroad industry. In the automotive industry, current automotive vehicle processing systems are complex and include many different components (e.g., processors) for managing or controlling different functions (e.g., audio, video, climate control, engine management, and others) in a vehicle. For example, automotive vehicle processing systems are used to manage or control different functions of a vehicle, such as audio, video, climate control, and engine management.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 is a block diagram of the device, illustrating additional details related to execution of processing tasks on an auxiliary processing device, according to an example;

FIG. 3 is a block diagram of an example computing device, in which one or more features of the disclosure can be implemented;

FIG. 4 is a block diagram illustrating example audio components in an automotive vehicle;

FIG. 5A is diagram illustrating a network configuration of a shared switch network;

FIG. 5B is diagram illustrating a redundant switch network in which features of the present disclosure can be implemented;

FIG. 6 is a diagram illustrating the example shown in FIG. 5B with additional detail;

FIG. 7 is a diagram illustrating another example a redundant switch network in which features of the present disclosure can be implemented;

FIG. 8 is a flow diagram illustrating an example method for allocating critical components and non-critical components of an automotive vehicle processing system according to features of the present disclosure; and

FIG. 9 is a table showing a list of components including their shareability with the critical and non-critical domains and their assignability to the critical and non-critical domains according to an example.

### DETAILED DESCRIPTION

Examples of different types of audio functions in an automotive vehicle include multi-media playback, active noise cancelation (canceling out sounds such as wind and tire noise while allowing a driver to hear sounds such as sirens and car horns), voice user interface (allowing a user to interact with the system through voice commands), hands-free phone calling, and sound generation.

Some audio functions, such as hands-free phone calling, and sound generation, have safety critical requirements. For example, hands-free phone calling safety critical requirements include being able to make an automated emergency call (e.g., in case of an accident), driver alerts and exterior pedestrian alerts for electric vehicles). In addition, sound generation safety critical requirements include driver alerts (e.g., sounds alerting driver of various conditions such as objects, people, other cars, paying attention, and lane changing) and exterior pedestrian alerts (e.g., for electric vehicles which do make less noise than combustion engine vehicles).

In contrast to non-critical processors in a safety critical system (e.g., safety critical system of an automotive vehicle), it is beneficial for critical processors to have dedicated critical resources (e.g., memory, memory interfaces, and input/output (1/O) devices), separate from non-critical resources, to ensure quality of service in the event that a portion of the overall system fails (e.g., during an emergency). That is, for safety-critical systems and applications, it is important to separate (e.g., isolate) a subsystem (e.g., processor and resources) used to execute safety-critical applications from other subsystems to ensure freedom from interference (FFI) (i.e., “absence of cascading failures between two or more elements that could lead to the violation of a safety requirement”). However, it is challenging for system designers and application developers to anticipate how to partition effective hardware resources for safety-critical workloads vs non-critical workloads. Also, because safety workload requirements are evolving (changing), a fixed partition of hardware is not flexible to meet these evolving requirements.

FFI principles can be satisfied by physically separating the critical resources from non-critical resources onto separate chips. However, placing the critical resources and non-critical resources onto separate chips is not cost efficient.

Some conventional techniques place the critical components and non-critical components onto the same chip, but physically separate the critical and non-critical components and use a single shared network switch for communications between critical and non-critical processors (e.g., digital signal processors (DSPs)) and critical and non-critical resources (e.g., memory, memory interfaces, I/O devices or other resources). That is, while placing critical components and non-critical components on the same chip reduces cost, conventional architectures are not flexible (e.g., not hardware flexible), especially if the mapping of hardware requirements is not matched closely to the application workload requirements. For example, if additional critical functions are added in the future, and additional DSPs are needed to execute the additional critical functions, conventional architectures are limited to the fixed number of critical components on the device.

Features of the present disclosure include devices and methods for assigning (e.g., allocating) dedicated critical resources (e.g., memory, memory interfaces and I/O devices) on the same chip with non-critical resources while maintaining a quality of service for the critical resources as well as flexibility to application developers to manage workloads and performance (e.g., allowing application developers to reallocate DSPs from the non-critical domain of a processing device (e.g., an audio coprocessor (ACP) into the critical domain).

Features of the present disclosure include assigning processors (e.g., digital signal processors (DSPs)) of a processing device (e.g., ACP) to a criticality domain level of a safety critical system. For example, a safety critical system can include two criticality domain levels (e.g., a critical domain and a non-critical domain) and the processors are assigned as critical processors or non-critical processors. Features of the present disclosure can be implemented for a safety critical system having any number of criticality domain levels (e.g., 3 or more levels each defining a different level of criticality from a most critical level to a least critical level) and the processors are assigned to the different criticality domain levels. However, for simplified explanation, examples are described herein using 2 criticality domain levels.

When two criticality domain levels are used, the resources are assigned as critical resources and non-critical resources. A processor assigned as a critical processor is permitted to access critical resources but not non-critical resources, and a processor assigned as a non-critical processor is permitted to access non-critical resources but not critical resources, with the exception of a limited shared memory resource.

The processing device (e.g., ACP) includes an interconnect network comprising connectivity pathways (e.g., non-shared, separate pathways), within an overall shared connectivity pathway, between each of the plurality of processors and the plurality of resources (e.g., memory, memory interfaces, storage, I/O devices or other resources).

Isolated pathways are created, via the shared pathway, between the plurality of processors and the plurality of resources, based on which of the plurality of processors are assigned to one or more of the plurality of criticality domain levels to access one or more of the plurality of resources. The isolated pathways are created, dynamically at boot time or run time, such that one or more of the separate pathways of the interconnect network are isolated from one or more other separate pathways of the interconnect network.

In one example, the interconnect network is a redundant switch network comprising a plurality of redundant switches and the isolated pathways are created between the processors and resources by disabling one or more of the redundant switches of the network based on which of the assigned critical processors (or which of the processors assigned to one or more criticality domain levels, such as one or more levels at or above a criticality domain threshold) are determined to access one or more of the plurality of resources.

Alternatively, the isolated pathways of an interconnect network are created (i.e., configured), at boot time or run time, via programmable logic to suit a particular application. The programmable logic can include one or more programmable logic devices (PLDs) configured to perform logic functions. Examples of such programmable logic include simple programmable logic devices (SPLDs) (e.g., programmable array logic (PAL), a programmable logic array (PLA) or other type of array logic), complex programmable logic devices (CPLDs) and Field-Programmable Gate Arrays (FPGAs). The programmable logic can be programmed, for example, using any of the processors (e.g., DSPs, the host processor), a programmable logic controller (PLC), or another processing device.

A portion (components) of the programmable logic can be used for safety critical configuration while another portion (other components) of the programmable logic can be designated for non-critical configuration. Reconfigured logic can be targeted to include only the network connections or a complete subsystem, which includes a plurality of subcomponents, such as memory, a memory controller, one or more processors (e.g., digital signal processors (DSPs)), and input/output (I/O) channels that in combination comprise a complete audio processing system for critical audio or non-critical audio.

The configuration of the interconnect networks can be unlocked until the system goes through a complete configuration sequence at boot time. Alternatively, a separate “root-of-trust” in the critical domain can manage the configuration resources with exclusive write access through a secure, dedicated interface, such that the system could be reconfigured with a soft reboot, or through a software-managed dynamic reconfiguration.

For fixed domain processors (e.g., DSPs that intrinsically belong to either the critical domain or the non-critical domain), portions of the interconnect networks can be separately consolidated into single interconnect networks that are connected to components within the same fixed domain.

A processing device for allocating components of a safety critical system is provided. The processing device comprises a plurality of resources including memory, and a host processor. The plurality of processors are connected to the plurality of resources via a shared pathway of a network and configured to execute an application based on instructions from the host processor. Isolated pathways are created, via the shared pathway, between the plurality of processors and the plurality of resources, based on which of the plurality of processors are assigned to one or more of the plurality of criticality domain levels to access one or more of the plurality of resources.

A method for allocating components of a safety critical system comprising: assigning, by a host processor, each of a plurality of processors, which execute an application based on instructions from the host processor, to a criticality domain level of a plurality of criticality domain levels; creating, via a shared pathway of a network connecting the plurality of processors to a plurality of resources, isolated pathways between the plurality of processors and the plurality of resources based on which of the plurality of processors are assigned to one or more criticality domain levels of the plurality of criticality domain levels to access one or more of the plurality of resources; and executing, by the plurality of processors, the application using the network.

A non-transitory computer readable medium comprising instructions thereon for causing a computer to execute a method for allocating components of a safety critical system, the instructions comprising: assigning, by a host processor, each of a plurality of processors, which execute an application based on instructions from the host processor, to a criticality domain level of a plurality of criticality domain levels; creating, via a shared pathway of a network connecting the plurality of processors to a plurality of resources, isolated pathways between the plurality of processors and the plurality of resources based on which of the plurality of processors are assigned to one or more criticality domain levels of the plurality of criticality domain levels to access one or more of the plurality of resources; and executing, by the plurality of processors, the application using the network.

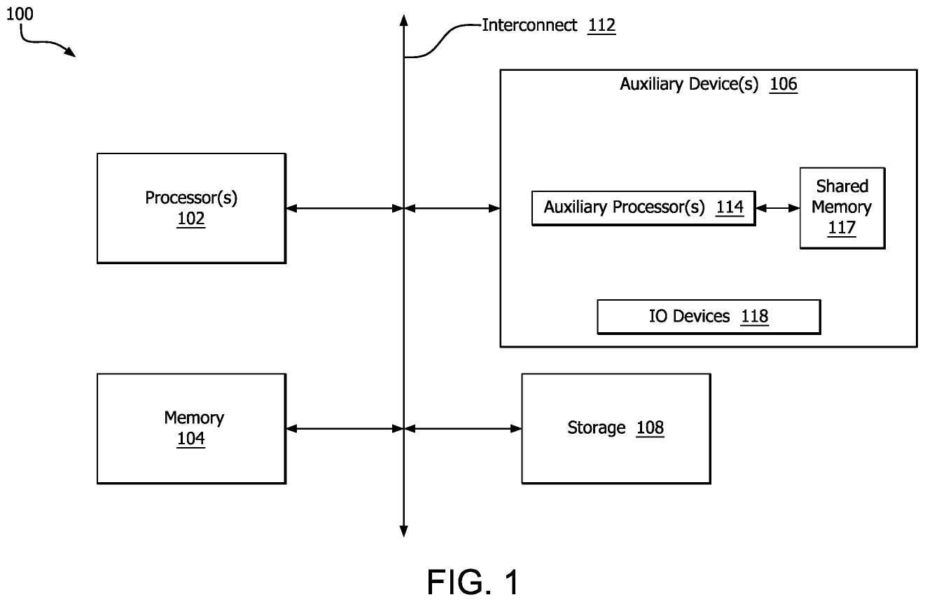

FIG. 1 is a block diagram of an example computing device 100 in which one or more features of the disclosure can be implemented. In various examples, the computing device 100 is one of, but is not limited to, for example, a computing device of a safety critical system (e.g., a safety critical system of an automotive vehicle), a computer, a gaming device, a handheld device, a set-top box, a television, a mobile phone, a tablet computer, or other computing device. For example, as described in examples provided herein, computing device 100 can be a computing device in an automotive vehicle, and can include a co-processor (e.g., an audio coprocessor (ACP)) or other processing device which comprises a plurality of processors (e.g. DSPs) each configured to perform functions (e.g., audio functions) (e.g., a safety critical system of an automotive vehicle having two or more criticality domain levels).

The device 100 includes, without limitation, one or more processors 102, a memory 104, one or more auxiliary devices 106 and storage 108. An interconnect network 112, which can be a bus, a combination of buses, and/or any other communication component, communicatively links the processor(s) 102, the memory 104, the auxiliary device(s) 106 and the storage 108.

In some examples described herein, the interconnect network 112 is merely configured to efficiently route data and control signals between fixed resources (e.g., memory and storage) and processors of a subsystem. For example, as described herein, isolated pathways of an interconnect network are created (e.g., dynamically at boot time or runtime) by a host processor (e.g., a CPU) by disabling one or more of the redundant switches of the interconnect network based on criticality levels of the resources and the processors.

In other examples described herein, the interconnect network 112 comprises programmable logic such as for example SPLDs, CPLDs or FPGAs. For example, as described herein, isolated pathways of an interconnect network are created (e.g., dynamically at boot time or runtime) by configuring or reconfiguring the programmable logic of the interconnect network based on criticality levels of the resources and the processors and/or to suit a particular application.

In various alternatives, the processor(s) 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the processor(s) 102, such as on the same chip or in an interposer arrangement, and/or at least part of the memory 104 is located separately from the processor(s) 102. The memory 104 includes a volatile or non-volatile memory, for example, random access memory (RAM), dynamic RAM, or a cache.

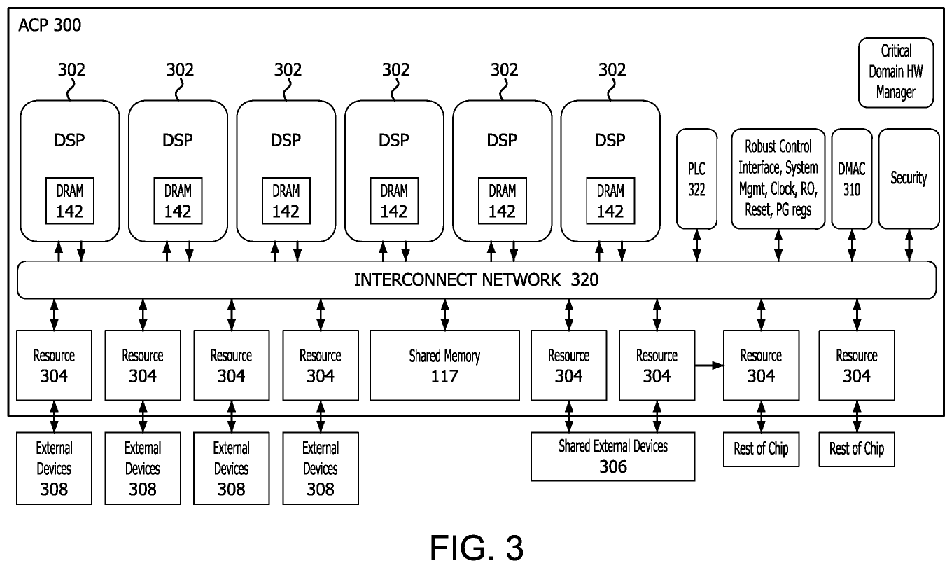

The storage 108 includes a fixed or removable storage, for example, without limitation, a hard disk drive, a solid state drive, an optical disk, or a flash drive. The auxiliary device 106 is for example, a co-processor (e.g., an ACP such as ACP 300 shown in FIG. 3), and includes, without limitation, one or more auxiliary processors 114 (e.g., DSPs), and/or one or more input/output (“IO”) devices. The auxiliary processor(s) 114 include, without limitation, a processing unit capable of executing instructions, such as a central processing unit, a DSP, a graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor. In some examples, the auxiliary processor(s) 114 include an accelerated processing device (“APD”). In addition, although processor(s) 102 and auxiliary processors 114 are shown separately in FIG. 1, in some examples, processor(s) 102 and auxiliary processors 114 can be on the same chip.

As described in more detail herein, each auxiliary processors 114 is for example, a digital signal processor (DSP) configured to perform functions (e.g., audio functions) in a safety critical system of an automotive vehicle. For example, each auxiliary processors 114 is a DSP in an ACP (such ACP 300 shown in FIG. 3), with each DSP comprising local instruction read access memory (e.g., IRAM 140) and local data RAM (DRAM 142), including cache memory (e.g., L1 cache). Each DSP is configured to transfer data (e.g., via a DMA controller).

The one or more I/O devices 118 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display, a speaker, a digital serial audio interface (e.g., an I2S interface or Time Division Multiplexing (TDM) interface), a printer, a haptic feedback device, one or more lights, an antenna, or a network connection (e.g., a wireless local area network card for transmission and/or reception of wireless IEEE 802 signals.

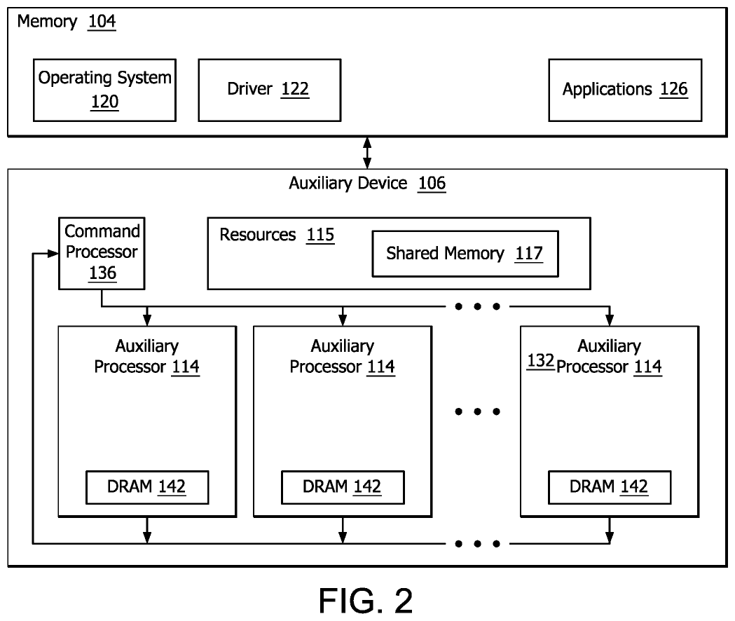

FIG. 2 is a block diagram of the device, illustrating additional details related to execution of processing tasks on the auxiliary device 106, according to an example. The processor 102 maintains, in system memory 104, one or more control logic modules for execution by the processor(s) 102. The control logic modules include an operating system 120, a driver 122, and applications 126, and may optionally include other modules not shown. These control logic modules control various aspects of the operation of the processor(s) 102 and the auxiliary device 106. For example, the operating system 120 directly communicates with hardware and provides an interface to the hardware for other software executing on the processor(s) 102. The driver 122 controls operation of the auxiliary device 106 by, for example, providing an application programming interface (“API”) to software (e.g., applications 126) executing on the processor(s) 102 to access various functionality of the auxiliary device 106.

The auxiliary device 106 is, for example a co-processor (e.g., ACP) which executes commands, via command processor 136, received from a host processor (e.g., processor(s) 102) and programs for selected functions, such as operations for performing critical and non-critical functions in a safety critical system (e.g., a safety critical system of an automotive vehicle). For example, each auxiliary processor 114 is a DSP in an ACP configured to perform audio functions for an automotive vehicle in a safety critical or non-critical domain. Each auxiliary processor 114 (e.g., DSP) includes a local DRAM 142 and accesses resources 115, which includes shared memory 117.

FIG. 3 is a block diagram of example ACP 300, in which one or more features of the disclosure can be implemented. The ACP 300 is merely an example of an auxiliary processing device (e.g., auxiliary device(s) 106 shown in FIGS. 1 and 2). Features of the present disclosure can be implemented for any type of auxiliary processing device in a computing device of a safety critical system (e.g., a safety critical system of an automotive vehicle). In the configuration shown in FIG. 3, the critical and non-critical domains are merged into the ACP 300. As shown, the ACP 300 includes an interconnect network 320.

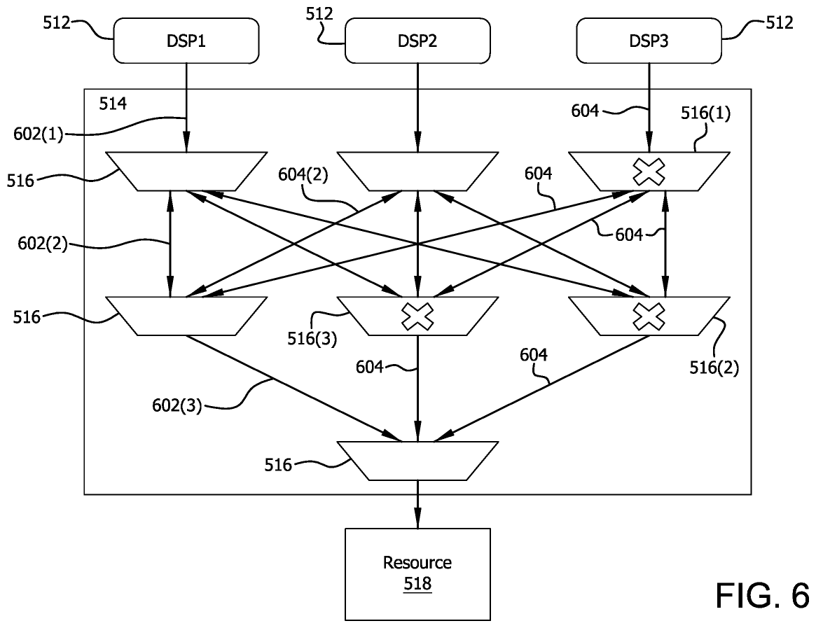

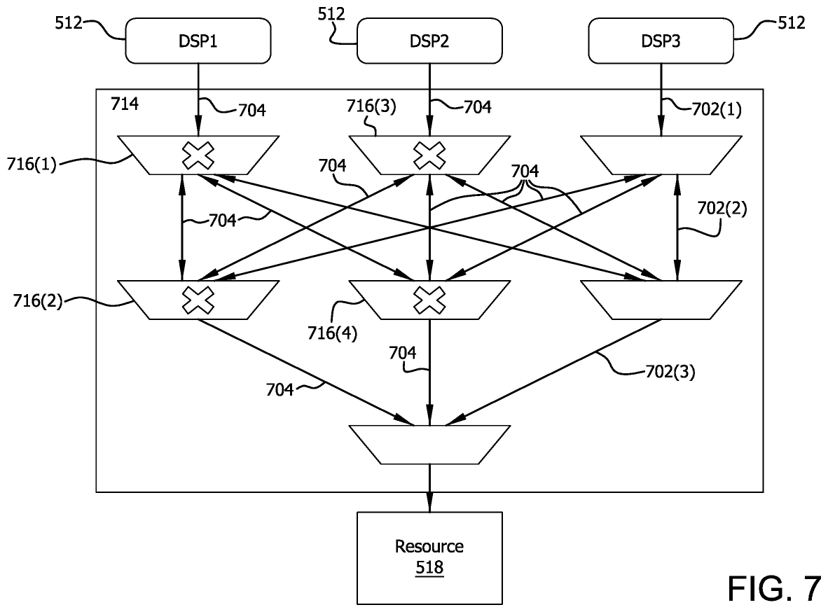

In some examples described herein, the interconnect network 320 is a combined critical and non-critical redundant switch network configured to efficiently route data and control signals between fixed resources (e.g., memory and storage) and processors of a subsystem using a plurality of redundant switches. For example, as described in more detail below with regard to FIGS. 6 and 7, processors (e.g., DSPs 302) are assigned as critical and non-critical processors and isolated pathways are created (e.g., dynamically at boot time or runtime) by a host processor (e.g., a CPU) by selecting redundant switches to be disabled (fenced off) based on which critical DSPs are determined to target an identified resource (e.g., an identified portion of memory).

Alternatively, the interconnect network 320 comprises programmable logic. Examples of programmable logic can include SPLDs, CPLDs or FPGAs. For example, isolated pathways of the interconnect network 320 are created (e.g., dynamically at boot time or runtime) by configuring or reconfiguring the programmable logic of the interconnect network based on criticality levels of the resources and the processors and/or to suit a particular application. The programmable logic can be programmed, for example, using any of the DSPs 302, a host processor (e.g., a CPU 102), a programmable logic controller (PLC 322), or another processing device.

The ACP 300 is, for example, part of an accelerated processing unit (APU) located on the same chip. The ACP 300 is connected to the APU (e.g., connected to other processors and memory of the APU via a system bus (e.g., interconnect 112, but not shown in FIG. 3). The ACP 300 integrates DSPs with associated data routing and bridging, direct memory access (DMA), interrupt support infrastructure and I/O interfaces.

The ACP 300 includes a plurality of DSPs 302, each having a local DRAM 142. The total number of DSPs shown in FIG. 3 and the number of DSPs shown in each domain in FIG. 3 are merely examples. Features of the present disclosure can be implemented for an ACP having any total number of DSPs and any number of DSPs in each domain.

Each of the resources 304, shared memory 117, shared external devices 306, and external devices 308, are accessible (prior to disabling of redundant switches) by the DSPs 302 to perform audio functions of an automotive vehicle. The number of resources and types of resources shown in FIG. 3 is merely an example. Features of the present disclosure can be implemented using any number and types of resources for performing audio functions of an automotive vehicle.

Data from memory (e.g., system memory 102, shared memory 117, that is processed by each DSP 302 enters and leaves the block through a system interface not shown. The direct memory access controller (DMAC) 310 utilizes 128-bit interface and multiple concurrent accesses to stream data and code memory from system memory 108. Accesses to system memory 108 undergoes address translation specified by the mapping tables located in shared memory 117.

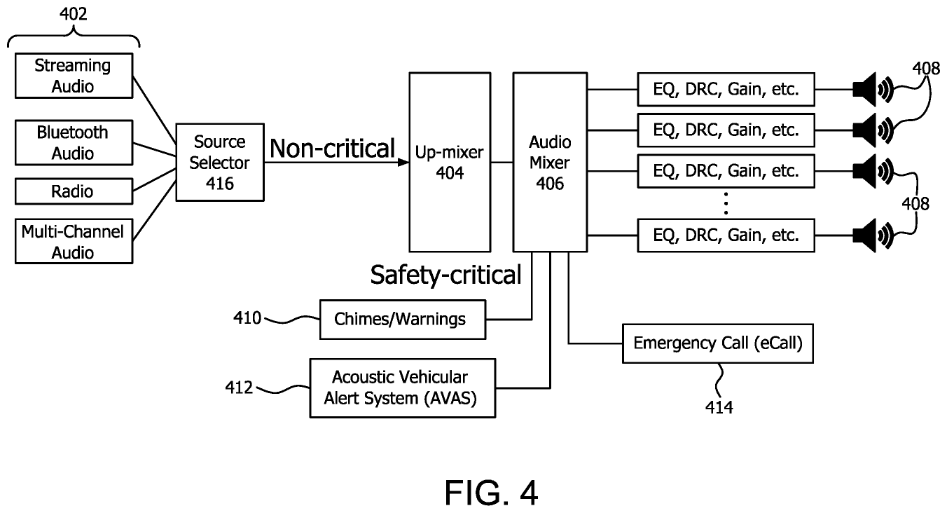

FIG. 4 is a block diagram illustrating example audio components in an automotive vehicle.

Speakers of an automobile are used to generate sound for critical functions, such as driver alerts, as well as generating sound for non-critical functions, such as sound for music from the stereo. However, an automobile has a fixed set of speakers. Accordingly, it is crucial that sound is generated at one or more speakers (and heard by a driver) for critical functions even if sound is being generated for non-critical functions.

As shown in the example at FIG. 4, audio signals from different non-critical domain sources (e.g., streaming audio, Bluetooth audio, radio, multi-channel audio) 402 are selected, via source selector 416, up-mixed by up-mixer 404 and mixed by audio mixer 406. Audio signals from different safety-critical domain sources (e.g., chimes/warning component 410 used to generate interior alerts to drivers or exterior alerts to pedestrians, acoustic vehicular alert system (AVAS) component 412 used to generate engine sound alerts to pedestrians in electric vehicles, and emergency call (eCall) component 414 used to generate emergency calls such as in the case of a crash) are also provided to audio mixer 406, which mixes and provides sound signals from the different non-critical domain sources 402 and safety-critical sources to be processed (e.g., equalized (EQ), compressed for example using dynamic range compression (DRC), gain processed, delayed, etc.) and provided to speakers 408, which generate sound from the processed signals. The data generated by each of the components in FIG. 4 are, for example, mapped to corresponding different DSPs 302 of the ACP 300.

The audio signals from the different non-critical domain sources 402 and safety-critical domain sources 410, 412, 414 are generated at the speakers 408 such that sound (e.g., driver alert chime) from critical domain sources 410, 412, 414 will still be generated (and heard by a driver) while sound (e.g., music from the radio) from a non-critical domain source 402 is also being generated at the speakers 408.

The audio mixer 406, the chimes warning source (e.g., hardware such as processor(s) and memory used to generate the chimes) 410, the AVAS source (hardware used to generate engine sound alerts) 412, and eCall source (e.g., hardware used to generate the emergency telephone calls) 414 are all safety critical components which are used to execute safety-critical applications). Accordingly, to ensure FFI and maintain a quality of service in the case of a portion of the system failing, these critical components and their resources are separated from non-critical components and resources. However, as described above, placing the critical resources and non-critical resources onto separate chips is neither cost efficient nor flexible. In addition, mailbox interfaces 312 and cross domain time-division multiplexing (TDM) interfaces 313 (in the example shown in FIG. 3) are used to send data and information between the non-critical and safety-critical domains. However, the data and information sent via these components will not affect the operability of the components in the safety-critical domain if the components in the non-critical domain are disabled (e.g., due to a crash).

Accordingly, features of the present disclosure provide dedicated critical resources (e.g., memory and I/O devices) on the same chip with non-critical resources while maintaining a quality of service for the critical resources and providing flexibility to application developers to manage workloads and performance.

As described above, in some examples, the interconnect network of a processing device (e.g., subsystem of safety critical system of an automotive vehicle), is a redundant switch network configured to efficiently route data and control signals between fixed resources (e.g., memory and storage) and processors of a subsystem using a plurality of redundant switches.

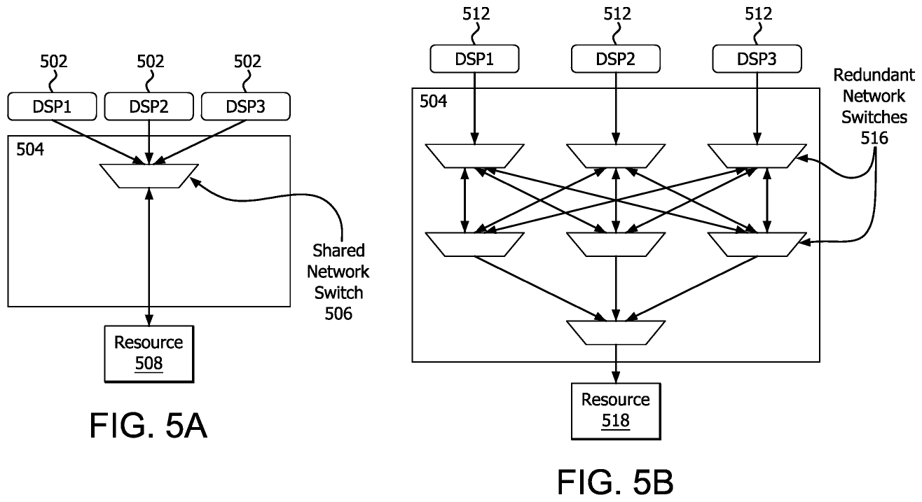

FIGS. 5A and 5B are diagrams illustrating differences between the configuration of a redundant switch network 504 with a shared network switch (i.e., without redundant switches) and the configuration of a switch network 514 using redundant switches (i.e., a redundant switch network) in which features of the present disclosure can be implemented. FIG. 5A is diagram illustrating a network configuration of a shared switch network. FIG. 5B is diagram illustrating a redundant switch network 514 in which features of the present disclosure can be implemented. The redundant switch network 514 is an example of the combined critical and non-critical redundant switch network 320 shown in FIG. 3.

For simplified explanation, the number of DSPs 512, the number of redundant network switches 516 and the single resource 518 (e.g., memory, memory interface, I/O device) shown in FIG. 5A is merely an example. Features of the present disclosure can be implemented using any number of DSPs, any number of redundant network switches and any number of resources.

The DSPs 502 and 512 shown in FIGS. 5A and 5B are merely examples of a type of processor. Features of the present disclosure can be implemented with any type of processor configured to initiate transaction (e.g., request to access memory) and receive data from a resource (e.g., receive requested data from memory) through a network.

The shared network switch 506 in FIG. 5A and redundant network switches 516 in FIG. 5B can be any type of network logic switch (e.g., multiplexor).

In the configuration shown in FIG. 5A, if a transaction, sent from a DSP in the non-critical domain (e.g., one of the DSPs 502) to shared resource 508 (e.g., a shared portion of memory), does not get completed because one or more components in the non-critical domain are disabled or not functional, the uncompleted transaction can negatively impact transactions from the critical domain DSPs (e.g., non-critical DSPs 502). For example, as shown in FIG. 5A, each of the DSPs 502 share the same network switch 506. Using the shared network configuration shown in FIG. 5A, if a transaction initiated by non-critical DSP 2 or non-critical DSP 3 cannot be completed (e.g., requested data is not returned to DSP 2 or non-critical DSP 3 due to loss of power to the shared network switch 506 or a program malfunction), then critical DSP 1 transactions, via the shared network switch 506, will also be negatively impacted.

That is, because critical and non-critical DSPs and resources are not separated (i.e., each of the DSPs 502 share the same pathway between the shared network switch 506 and the shared memory 508), a transaction from the non-critical DSP 1, destined to shared memory 508, can be left in an uncompleted state on the shared memory's arbiter due, for example, to a program malfunction or loss of power. Accordingly, if the critical DSP 1 later accesses the same shared memory 508, the arbiter or the interconnect network may block critical DSP 1's transaction due to the uncompleted prior transaction, and critical DSP 1 will therefore be unable to make forward progress.

Accordingly, the critical and non-critical components should be separated from each other. However, as described above, placing the critical resources and non-critical resources onto separate chips is not cost efficient. In addition, physically separating the critical and non-critical resources will make the hardware inflexible, especially if the mapping of hardware requirements is not matched closely to the application workload requirements.

FIG. 5B is diagram illustrating a technique of creating isolated pathways using redundant network switches 516 according to features of the present disclosure. Although the redundant switches 516 in the network 514 use additional routing and area (e.g., additional silicon), the additional area is relatively small (e.g., the additional area in the network is less than 1% of the ACP area). In addition, as described in more detail with regard to FIG. 6, by disabling (e.g., fencing off) selected redundant network switches (e.g., switches 516), critical and non-critical components can be placed on the same chip while ensuring a quality of service for critical resources and providing more flexibility to application developers to manage workloads and performance.

FIG. 6 is a diagram illustrating the example shown in FIG. 5B with additional detail. In the example shown at FIG. 5B and FIG. 6, DSP1 and DSP 2 are assigned as critical DSPs and DSP 3 is assigned as a non-critical DSP.

At cold boot time (i.e., before the audio application begins executing), one or more DSPs 512 are assigned by a host processor (e.g., processor 102, such as a CPU) as critical processors, one or more DSPs 512 are assigned by the host processor as non-critical processors and one or more of the redundant network switches 516 are selected by the host processor to be disabled (fenced off) based on which critical DSPs are determined to target an identified resource (e.g., an identified portion of memory).

The determination of which DSPs are to be assigned as critical DSPs and which DSPs are to be assigned as non-critical DSPs is made (e.g., by an application developer) to suit a particular application or use case. The determination of which resources (e.g., portions of memory) are to be assigned as a target critical portion of memory (accessible to the assigned critical DSPs) is also made (e.g., by an application developer) to suit a particular application or use case.

For example, referring to FIG. 6, at cold boot time, DSP 1 and DSP 2 are assigned (e.g., based on the particular application) as critical processors and DSP 3 is assigned (e.g., based on the particular application) as a non-critical processor. Additionally, resource 518 (e.g., an identified portion of memory) is assigned (e.g., based on the particular application) as a target critical portion of memory to be accessible by critical DSP 1 and critical DSP 2. That is, critical DSP 1 and critical DSP 2 are able to access the target portion of memory 518 and DSP 3 is not able to access the target portion of memory 518.

Redundant network switches 516(1), 516(2) and 516(3) are selected and disabled, by the host processor, based on resource 518 assigned as a critical resource to be targeted by critical DSP 1 and critical DSP 2. That is, by disabling switches 516(1), 516(2) and 516(3), isolated pathways are dynamically created between DSP 1 and resource 518 and between DSP 2 and resource 518. Accordingly, requests to access data from critical memory portion 518 are prevented (fenced off) from being sent along pathway portions 604.

However, the remaining redundant network switches (i.e., switches other than 516(1), 516(2) and 516(3)) are not disabled. Accordingly, the requests to access data from critical memory portion 518 data are not prevented (allowed) along pathway portions 602(1)-602(4). Because the pathways between each DSP 512 and the critical memory portion 518 are separated and selected redundant network switches are disabled, critical DSP 1 can access critical memory portion 518 along pathway portions 602(1)-602(3) and critical DSP 2 can access critical memory portion 518 along pathway portions 602(4) and 602(3). That is, the separate pathway (comprising pathway portions 602(1)-602(3)) and the separate pathway (comprising pathway portions 602(4) and 602(3)) become isolated from other pathways. Accordingly, critical components (e.g., critical DSP 1, critical DSP 2 and critical memory portion 518) and non-critical components (e.g., non-critical DSP 1 and non-critical memory portions (not shown in FIG. 6)) can be placed on the same chip while ensuring a quality of service. In addition, more flexibility is provided to application developers to manage workloads and performance. For example, if additional critical functions are added in the future, and additional DSPs are needed to execute the additional critical functions, features of the present disclosure allow additional flexibility for application developers to reallocate DSPs from the non-critical domain of the ACP 300 into the critical domain.

In the example described with regard to FIG. 6, the DSPs are assigned as critical or non-critical processors and redundant network switches are selected and disabled at cold boot time via a hardware lock mechanism (e.g., lock mechanism 318 in FIG. 3), which cannot be altered by software.

FIG. 7 is a diagram illustrating another example a redundant switch network 714 in which features of the present disclosure can be implemented. The redundant switch network 714 is another example of the combined critical and non-critical redundant switch network 320 shown in FIG. 3.

In the example shown at FIG. 7, DSP1 and DSP 2 are assigned as non-critical DSPs and DSP 3 is assigned as a critical DSP.

At cold boot time (i.e., before the audio application begins executing), DSP 1 and DSP 2 are assigned as non-critical processors and DSP 3 is assigned as a critical processor. Additionally, resource 518 (e.g., an identified portion of memory) is assigned as a target critical portion of memory to be accessible by critical DSP 3. That is, critical DSP 3 is determined to be able to access the target portion of memory 518 and DSP 1 and DSP 2 are determined to not be able to access the target portion of memory 518.

Based on resource 518 assigned as a critical resource to be targeted by critical DSP 3, redundant network switches 716(1)-716(4) are selected and disabled. Accordingly, requests to access data from critical memory portion 518 are prevented (fenced off) from being sent along pathway portions 704.

However, the remaining redundant network switches (i.e., switches other than 716(1)-716(4)) are not disabled. Accordingly, the requests to access data from critical memory portion 518 data are not prevented (i.e., are allowed) along pathway portions 702(1)-702(3). Because the pathways between each DSP 512 and the critical memory portion 518 are separated and the selected redundant network switches 716(1)-716(4) are disabled, critical DSP 3 can access critical memory portion 518 along pathway portions 702(1)-702(3). Accordingly, critical components (e.g., critical DSP 3 and critical memory portion 518) and non-critical components (e.g., non-critical DSP 1, non-critical DSP 2 and non-critical memory portions (not shown in FIG. 6)) can be placed on the same chip while ensuring a quality of service. In addition, the assigning of processors (e.g., DSPs) as either critical or non-critical and the disabling of selected redundant network switches based on which critical processors are determined to target an identified critical resource, more flexibility is provided to application developers to manage workloads and performance.

Alternatively, instead of using redundant switches in an interconnect network (as shown in FIGS. 6 and 7), an interconnect network comprises programmable logic such as for example SPLDs, CPLDs or FPGAs. In this example, the isolated pathways of the interconnect network are dynamically created by configuring (or reconfiguring), at boot time or run time, the programmable logic of the interconnect network based on criticality levels of the resources and the processors and/or to suit a particular application. A portion (components) of the programmable logic can be used for safety critical configuration while another portion (other components) of the programmable logic can be designated for non-critical configuration.

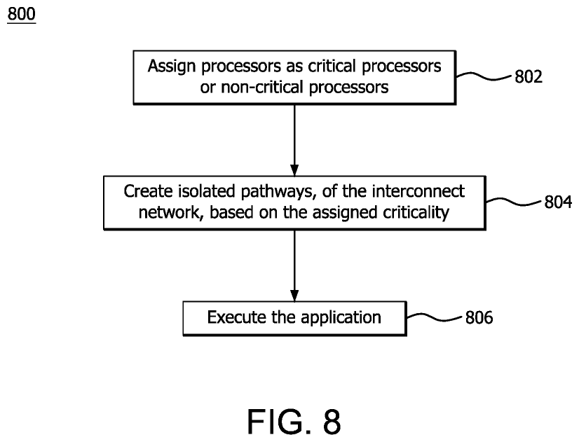

FIG. 8 is a flow diagram illustrating an example method 800 for allocating critical components and non-critical components of an automotive vehicle, according to features of the present disclosure. Each of the tasks and functions described below with regard to the method 500 are, for example, executed on an auxiliary device (e.g., auxiliary device 106, ACP 300).

As shown at block 802, the method 800 includes assigning processors (e.g., digital signal processors (DSPs)) of a processing device (e.g., an audio coprocessor (ACP)) to one of a plurality of criticality domain levels. For example, as described above with regard to the example in FIG. 6, DSP1 and DSP 2 are assigned by a host processor (e.g., processor 102, such as a CPU) as critical DSPs and DSP 3 is assigned by the host processor as a non-critical DSP. In addition, resource 518 (e.g., an identified portion of memory) is assigned by the host processor as a target critical portion of memory to be accessible by critical DSP 1 and critical DSP 2 to suit a particular application to be executed. The determination of which DSPs are to be assigned as critical DSPs and which DSPs are to be assigned as non-critical DSPs is made (e.g., by an application developer) to suit a particular application or use case. The determination of which resources (e.g., portions of memory) are to be assigned as a target critical portion of memory (accessible to the assigned critical DSPs) is also made (e.g., by an application developer) to suit a particular application or use case.

For example, when two criticality domain levels (critical and non-critical domain levels) are used, each processor is assigned as either a critical processor or a non-critical processor and the resources are assigned as critical resources and non-critical resources. A processor assigned as a critical processor is permitted to access critical resources but not non-critical resources, and a processor assigned as a non-critical processor is permitted to access non-critical resources but not critical resources (with the exception of a limited shared memory resource).

When more than two criticality domain levels (e.g., each level defining a different level of criticality from a most critical level to a least critical level) are used, processors and resources are assigned to different criticality domain levels (e.g., each processor and each resource is assigned to one of the criticality domain levels).

As shown at block 804, the method 800 includes creating isolated pathways, of the interconnect network, based on the assigned criticality. For example, the isolated pathways of the interconnect network are created, at block 804, by selecting, by the host processor, one or more of a plurality of redundant switches (e.g., switches 516) in a network (e.g., network 514) to be disabled (fenced off) and disabling, by the host processor, the selected one or more switches.

When two criticality domain levels (critical and non-critical domain levels) are used, one or more of the redundant switches are selected and disabled based on which of the processors are assigned as critical processors and, therefore, are determined to target an identified critical resource (e.g., an identified critical portion of memory. For example, with reference to FIG. 6, when two criticality domain levels are used, redundant switches 516(1), 516(2) and 516(3) are selected to be disabled because DSP 1 and DSP 2 are assigned as critical processors and, therefore, are able to access critical resource 518. However, DSP 3 is assigned as a-non-critical processor and is not able to access critical resource 518. Accordingly, redundant switches 516(1), 516(2) and 516(3) are selected to be disabled such that

That is, the disabling of the 516(1), 516(2) and 516(3) enables critical DSP 1 to access the critical resource 518 via a pathway (i.e., via pathway portions 602(2) and 602(3)) and enables critical DSP 2 to access the critical resource 518 via a pathway (i.e., via pathway portions 602(4) and 602(3)) while preventing DSP 3 from accessing the critical resource 518.

Accordingly, no transaction can be made from non-critical DSP 3 to critical resource 518 and, therefore, no uncompleted transaction between non-critical DSP 3 and critical resource 518 will occur (e.g., due to a program malfunction or loss of power) and any transactions from critical DSP 1 or critical DSP 2 will not be blocked due to such an uncompleted prior transaction.

When more than two criticality domain levels (e.g., each level defining a different level of criticality from a most critical level to a least critical level) are used, one or more of the redundant switches are selected to be disabled based on which of the processors (e.g., DSPs) are assigned to the one or more criticality domain levels. For example, one or more of the redundant switches are selected to be disabled based on which of the processors (e.g., DSPs) are assigned to one or more levels at or above a criticality domain threshold (e.g. a high criticality level and a medium criticality level is at or above a criticality domain threshold and able to access the critical resources while a low criticality level is below the criticality domain threshold and not able to access the critical resources.

The selected one or more redundant network switches are then disabled, by the host processor (e.g., CPU) based on the selection. For example, when two criticality domain levels are used, redundant switches 516(1), 516(2) and 516(3) are disabled (e.g., fenced off). The isolated pathways of an interconnect network are, for example, created via a set of redundant physical switches whose connectivity is configurable (e.g., at boot time or runtime) providing flexibility to assign each of the processors to mutually exclusive safety-critical or non-critical domains. The interconnect networks include redundant switches between processors and the shared resources (e.g., shared on-chip memory and memory interfaces to external memory). The configuration of the interconnect networks are managed in software at boot time, such that one or more DSPs and their associated resources (e.g., and memory, memory interfaces, accelerators) are assigned to the safety critical domain or non-critical domain and unused connections are closed off (e.g., fenced-off) via a hardware lock mechanism 318 which cannot be altered by software.

Alternatively, as described above, the isolated pathways of an interconnect network are dynamically created by configuring (or reconfiguring), at boot time or run time, the programmable logic of the interconnect network based on criticality levels of the resources and the processors and/or to suit a particular application. A portion (components) of the programmable logic can be used for safety critical configuration while another portion (other components) of the programmable logic can be designated for non-critical configuration. Reconfigured logic can be targeted to include the network connections or a complete subsystem (e.g., the ACP).

As shown at block 806, the method 800 includes executing, by the plurality of processors of the auxiliary processing device, an application using the network. For example, ACP 300 executes, via DSPs 512, an audio application in an automobile. During execution of the application, critical DSP 1 and critical DSP 2, which are determined to be able to access the target portion of memory 518, are used to execute critical functions by accessing the critical portion of memory 518.

The connectivity of the redundant physical switches, and alternatively the programmable logic, is dynamically configurable at boot time or runtime. For example, at boot time, the system can dynamically configure the switches (or alternatively the programmable logic) based on the detected hardware (e.g., processors and resources), settings (e.g., assigned criticality or other settings), and/or conditions to suit a particular application. At runtime: the system can dynamically configure the switches (or alternatively the programmable logic) based on changes that occur (e.g., changes to assigned criticality) while the system is running, after the boot process is complete. Because the connectivity of redundant physical switches, or alternatively, the programmable logic) is dynamically configurable (e.g., at boot time or runtime), flexibility is provided to assign each of the processors to mutually exclusive safety-critical or non-critical domains.

The configuration of the interconnect networks can be unlocked until the system goes through a complete configuration sequence at boot time. Alternatively, a separate “root-of-trust” in the critical domain can manage the configuration resources with exclusive write access through a secure, dedicated interface, such that the system could be reconfigured with a soft reboot, or through a software-managed dynamic reconfiguration.

For fixed domain processors (e.g., DSPs that intrinsically belong to either the critical domain or the non-critical domain), portions of the interconnect networks can be separately consolidated into single interconnect networks that are connected to components within the same fixed domain.

Non-critical domain components of an ACP are allowed to send and receive transactions with memory and processors (e.g., compute units or processor cores) via a system hub and shared memory network (SMN) interfaces as well as with other non-critical components within the ACP. Functionality of the non-critical domain is presumed to be dependent on the processor, the fabric and/or system memory functionality. Non-critical domain ACP components do not lose power in the event of a loss of power (e.g., system state S0 power), but their functionality can be impacted by the failure of powered components if power is lost abruptly (e.g., not through a normal system state transition). After initial cold-boot configuration and loading is completed, non-critical domain components are blocked from accessing critical domain components.

Critical domain components are isolated from the system hub and SMN interfaces and any other internal paths to the processor, fabric and system memory, as well as from all non-critical domain ACP components. Critical domain ACP components are presumed to require functionality to continue in the event of a partial or complete failure or crash of the processors, fabric and/or system memory. Critical domain components also continue to function in the event of a loss of S0 power. After domain isolation is enabled following initial cold-boot configuration through the system hub and SMN interfaces, the only allowable internal communication path between the critical and non-critical domains is through shared SRAM banks that are assigned as shared domain, and through specifically designated ACP-internal error management registers and interrupts. Register access path is shared between critical and non-critical domains.

Shared-domain SRAM banks allow access from both domains, but are designed such that a failed or hung transaction on one domain does not impede transactions on the other domain. The system firmware designer must be aware that a failure of a domain could result in data corruption in a shared-domain SRAM bank. No code and no data that affects DSP execution (e.g., stacks, pointers, etc.) should ever be placed in a shared-domain SRAM bank. A limited number of SRAM banks are typically assigned as shared-domain. Typical intended use cases include sending audio data streams and messages between the critical and non-critical domains.

At cold-boot time, domain division is disabled to allow for chip and secure processor (e.g., platform security processor (PSP)) initialization of each component. Domain division is enabled by a stateful one-time register bit switch that can be set by any DSP, but is cleared by a secure processor through its isolated sideband interface, or by a cold reset. The bit is read-only to the x86 domain. Domain assignments are configured before enabling domain division and are locked thereafter. In typical use cases, the ACP driver messages the ACP when it has completed initialization, and then domain division is enabled.

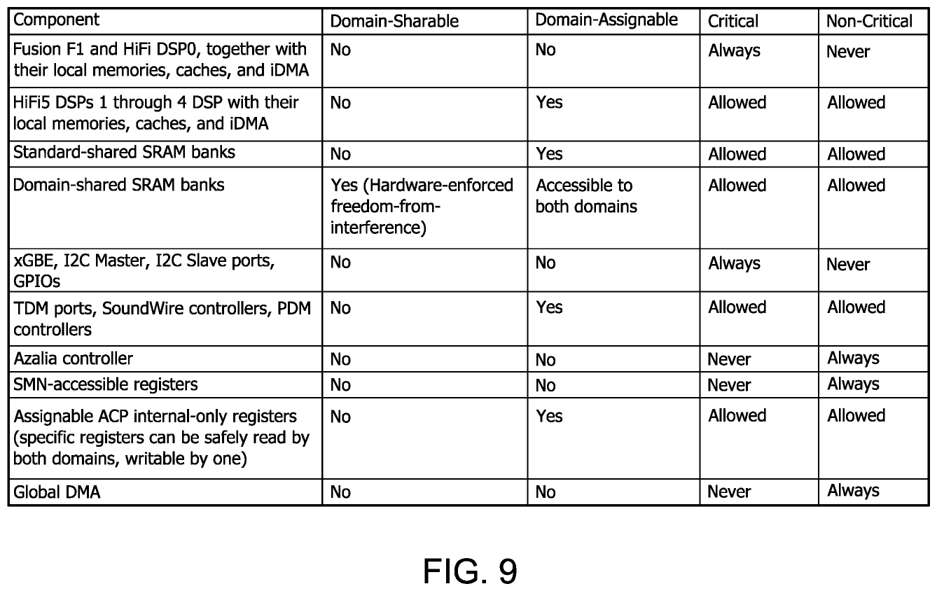

FIG. 9 is a table showing a list of ACP components including their shareability with the critical and non-critical domains and their assignability to the critical and non-critical domains according to an example. As shown in the example, at FIG. 9, some SRAM banks (i.e., domain-shared SRAM banks) are domain-sharable while other SRAM banks (i.e., standard-shared SRAM banks) and other components are not domain-sharable. The example shown at FIG. 9 also lists components which are domain-assignable (e.g., assignable to both domains) and components which are not domain-assignable (e.g., assigned to the critical domain but not the non-critical domain or assigned to the non-critical domain but not the critical domain). The domain-shareability and domain-assignability of the components shown in FIG. 9 is merely an example. Features of the present disclosure can be also implemented using domain-shareability and domain-assignability of components different than those shown in FIG. 9.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A processing device for allocating components of a safety critical system, the processing device comprising:
a plurality of resources including memory;
a host processor; and
a plurality of processors connected to the plurality of resources via a shared pathway of a network, and configured to execute an application based on instructions from the host processor,
wherein isolated pathways are created, via the shared pathway, between the plurality of processors and the plurality of resources, based on which of the plurality of processors are assigned to one or more of a plurality of criticality domain levels to access one or more of the plurality of resources.

2. The processing device of claim 1, wherein
the network comprises separate pathways between each of the plurality of processors and the resources via a plurality of redundant switches, and
the host processor is configured to create the isolated pathways by disabling one or more redundant switches of the plurality of redundant switches such that one or more of the separate pathways are isolated from one or more other separate pathways.

3. The processing device of claim 2, wherein the host processor is configured to:
assign, at boot time or run time of the application, each of the plurality of processors to one of the criticality domain levels; and
select, at boot time or run time of the application, the one or more redundant switches to be disabled.

4. The processing device of claim 1, wherein the processing device is an audio co-processor configured to execute an audio application for an automotive vehicle.

5. The processing device of claim 1, wherein one or more of the processors is a digital signal processor configured to execute audio functions in an automotive vehicle.

6. The processing device of claim 1, wherein the network comprises a plurality of separated pathways between each of the plurality of processors and the plurality of resources and the isolated pathways are created such that one or more of the separate pathways are isolated from one or more other separate pathways.

7. The processing device of claim 1, wherein the network comprises programmable logic; and
the isolated pathways in the network are created by configuring or reconfiguring the programmable logic.

8. The processing device of claim 7, wherein the isolated pathways are dynamically created, at boot time or run time of the application, via the programmable logic based on which of the plurality of processors are assigned to the one or more criticality domain levels.

9. The processing device of claim 1, wherein each of the plurality of processors assigned as a critical processor and each of the plurality of processors assigned as a non-critical processor are on a same chip.

10. The processing device of claim 1, wherein the safety critical system is a system of an automotive vehicle.

11. The processing device of claim 1, wherein,
the plurality of criticality domain levels comprise a non-critical domain level and a critical domain level, and
the host processor is configured to:
assign each of the plurality of processors as a critical processor or a non-critical processor, and
create the isolated pathways based on which of the processors are assigned as critical processors.

12. The processing device of claim 1, wherein
the plurality of criticality domain levels comprise three or more criticality domain levels, and
the host processor is configured to create the isolated pathways based on which of the processors are assigned to one or more levels at or above a criticality domain threshold.

13. A method for allocating components of a safety critical system, the method comprising:
assigning, by a host processor, each of a plurality of processors, which execute an application based on instructions from the host processor, to a criticality domain level of a plurality of criticality domain levels;
creating, via a shared pathway of a network connecting the plurality of processors to a plurality of resources, isolated pathways between the plurality of processors and the plurality of resources based on which of the plurality of processors are assigned to one or more criticality domain levels of the plurality of criticality domain levels to access one or more of the plurality of resources; and
executing, by the plurality of processors, the application using the network.

14. The method of claim 13, further comprising:
assigning, at boot time or run time of the application, each of the plurality of processors to the criticality domain level; and
creating, by the host processor, the isolated pathways by selecting, at boot time or run time of the application, one or more redundant switches, of a plurality of redundant switches, of the network to be disabled.

15. The method of claim 14, further comprising creating the isolated pathways by disabling the one or more redundant switches such that one or more separate pathways of the network are isolated from one or more other separate pathways of the network.

16. The method of claim 13, wherein the network comprises programmable logic and the method further comprises creating the isolated pathways by reconfiguring the programmable logic.

17. The method of claim 16, further comprising creating the isolated pathways by dynamically configuring, at boot time or run time of the application, the programmable logic.

18. The method of claim 13, wherein,
the plurality of criticality domain levels comprises a non-critical domain level and a critical domain level, and
the method comprises:
assigning each of the plurality of processors as a critical processor or a non-critical processor, and
creating the isolated pathways based on which of the processors are assigned as critical processors.

19. The method of claim 13, wherein the plurality of criticality domain levels comprises three or more criticality domain levels, and
the method comprises creating the isolated pathways based on which of the processors are assigned to one or more levels at or above a criticality domain threshold.

20. A non-transitory computer readable medium comprising instructions thereon for causing a computer to execute a method for allocating components of a safety critical system, the instructions comprising:
assigning, by a host processor, each of a plurality of processors, which execute an application based on instructions from the host processor, to a criticality domain level of a plurality of criticality domain levels;
creating, via a shared pathway of a network connecting the plurality of processors to a plurality of resources, isolated pathways between the plurality of processors and the plurality of resources based on which of the plurality of processors are assigned to one or more criticality domain levels of the plurality of criticality domain levels to access one or more of the plurality of resources; and
executing, by the plurality of processors, the application using the network.
